(19) United States
(12) Patent Application Publication
(10) Pub. No.: US 2012/0047003 A1
(43) Pub. Date: Feb. 23, 2012

(54) VIRAL OFFERS

(76) Inventors: Ayman Hammad, Pleasanton, CA (US); Prakash Prem Hariramani, San Francisco, CA (US); Victoria A. Kincaid, Sunnyvale, CA (US)

(21) Appl. No.: 13/211,185

(22) Filed: Aug. 16, 2011

Related U.S. Application Data
(60) Provisional application No. 61/374,405, filed on Aug. 17, 2010.

(51) Int. Cl. G06Q 30/02

(52) U.S. Cl. 705/14.1; 705/14.64

(57) ABSTRACT

Embodiments can relate to systems and methods involving viral offers. In one embodiment, a viral offer is sent to a communication device associated with a first user enrolled with a viral offer program operated by a viral offer server computer. After the viral offer is sent, an authorization request message for a transaction conducted by a second user is received. After receiving the authorization request message, a viral offer record associated with the viral offer is accessed. The viral offer record includes a velocity limit, and if the velocity limit has not been met, the velocity limit is updated.

### CROSS-REFERENCES TO RELATED APPLICATIONS

This application claims the benefit of U.S. Provisional Application No. 61/374,405, filed Aug. 17, 2010, entitled “VIRAL OFFERS,” which is herein incorporated by reference in its entirety for all purposes.

### BACKGROUND

Offers (e.g., coupons) are a useful marketing tool to enhance brand loyalty and introduce new products. By allowing customization of the effective duration and value of an offer, an offer provides a flexible incentive for a user to purchase a particular product or line of products.

Conventionally, offers have been available in printed form from sources such as newspapers. Increased adoption of electronic sources of information such as the world-wide-web, however, has led to the increase in popularity of electronic offers. Further, due to the nature of electronic content, it is possible for such offers to be forwarded from one user to another.

In addition, many users now own and operate a mobile phone or other mobile communication device. This renders such users accessible to the distribution of electronic coupons as they do their shopping, and moreover allows such distributed electronic coupons to be redeemed directly at the store location.

Accordingly, there is a need in the art for methods and systems allowing for the distribution and use of electronic coupons by mobile electronic devices.

### BRIEF SUMMARY

Embodiments can relate to systems and methods involving viral offers. In one embodiment, a viral offer is sent to a communication device associated with a first user enrolled with a viral offer program operated by a viral offer server computer. After the viral offer is sent, an authorization request message for a transaction conducted by a second user is received. After receiving the authorization request message, a viral offer record associated with the viral offer is accessed. The viral offer record includes a velocity limit, and if the velocity limit has not been met, the velocity limit is updated.

In another embodiment, a first user enrolls with the viral offer server computer before the viral offer is received. Enrolling with the viral offer server computer involves associating the user with a financial account.

In yet another embodiment, before receiving the authorization request message for the transaction conducted by the second user, a relevant set of users including the second user is sent to the communication device associated with the first user.

These and other embodiments of the invention are described in further detail below.

### BRIEF DESCRIPTION OF THE DRAWINGS

FIG. 1A is a block diagram of a system using viral offers, according to example embodiments.

FIG. 1B is a block diagram of a system using viral offers, according to example embodiments.

FIG. 1C is a block diagram showing modules of a mobile communication device, according to example embodiments.

FIG. 2 is a block diagram that shows modules of a viral offer server computer, according to example embodiments.

FIG. 3A is a flow diagram that shows a method for using viral offers, according to example embodiments.

FIG. 3B is a flow diagram that shows a method for using viral offers, according to example embodiments.

FIG. 4 is an exemplary screenshot for a viral offer, according to example embodiments.

FIG. 5 is an exemplary screenshot for a viral offer, according to example embodiments.

FIG. 6(a)-(c) are diagrams that show how various records relating to a viral offer are updated, according to example embodiments.

FIG. 7 is a sequence diagram that shows a method for sending a viral offer, according to example embodiments.

FIG. 8 is an exemplary screenshot for a viral offer request message, according to example embodiments.

FIG. 9 is an exemplary screenshot for a viral offer request message, according to example embodiments.

FIG. 10 is a diagram showing filters of a relevancy module, according to an example embodiment.

FIG. 11 is a block diagram illustrating the primary functional components of a computer or computing system that may be used to implement an element or component used in some embodiments of the present invention.

### DETAILED DESCRIPTION

Embodiments of the invention relate to methods and systems of using a payment processing network to track and process viral offers. As described below, a “viral offer” may refer to an electronic offer that can be transferred or copied between users. To track viral offers, embodiments of the invention may require the recipient of a viral offer to enroll in a cross-merchant or cross-issuer viral offer program before the viral offer can be used. Processing viral offers through a payment processing network provides a number of advantages, such as leveraging existing transaction equipment, providing multiple merchant or issuer viral offers, and tracking the effectiveness of viral offers.

Additionally, in embodiments of the invention, methods and systems can control the effects of viral offers in a number of ways. For example, the system may limit the number of times a viral offer can be redeemed (e.g., a “velocity limit” as described below). The velocity limit may be a global limit tied to the viral offer. The velocity limit may also be tied to an enrolled account associated with the system. Such control over viral offers may limit the risk to merchants or issuers by preventing a viral offer from being transferred to and redeemed by an undesirably large number of users. At the same time, such control over viral offers may provide sufficient but reasonable exposure to the viral offer campaign. By tying viral offers to an enrolled account associated with the system, embodiments of the invention may limit the ways fraudsters can circumvent velocity limits (e.g., by preventing the creation of fake accounts to receive additional offers).

To illustrate, a user may enroll in a viral offer program. A viral offer may then be sent to a mobile communication device (e.g., a smart phone) of the user, in the form of a Short Message Service (SMS) message, e-mail message, or any other suitable mode of communication over the Internet, a cellular network, or other wireless network. Once received, the user may want to send the viral offer to a second user. The viral offer may be forwarded to a viral offer server computer contained within or associated with a payment processing network. The viral offer server computer may determine whether the second user is enrolled in the viral offer program, and if so, send the viral offer to the second user. If the second user is not enrolled in the viral offer program, the viral offer server computer can send an enrollment request message in the form of an SMS, e-mail message, or any other suitable mode of communication over the Internet, a cellular network, or other wireless network, to a mobile communication device (e.g., a smart phone) associated with the second user prior to sending the viral offer. When the second user attempts to redeem the viral offer using the smart phone, or a credit card, debit card, or other portable consumer device, an authorization request message can be sent through the payment processing network and received by the viral offer server computer. After receiving the authorization request message, the viral offer server computer can access a record associated with the viral offer to determine if the velocity limit has been met. If the velocity limit has not been met, the viral offer server computer can update the velocity limit contained in the record. The viral offer can then be applied to the transaction by the payment processing network, the merchant conducting the transaction with the second user, or by the issuer associated with the payment account used by the second user to make the transaction.

Prior to discussing the example embodiments of the invention, a further description of some terms is provided below for a better understanding of the described embodiments.

As used herein, an “authorization request message” can refer to a message, or sequence of messages, that requests an issuer of a payment card or payment account to authorize a transaction. An authorization request message according to an embodiment of the invention may comply with ISO (International Organization for Standardization) 8583, which is a standard for systems that exchange electronic transactions made by cardholders or account holders using their payment accounts. An authorization request message according to other embodiments may comply with other suitable standards.

As used herein, an “authorization response message” can refer to a message, or sequence of messages, that responds to a merchant's and/or acquirer's request to authorize a transaction. An authorization response message according to an embodiment of the invention may comply with ISO 8583, which, as described above, is a standard for systems that exchange electronic transactions made by cardholders or account holders using their payment accounts.

As used herein, a “viral offer” can refer to an electronic offer that can be transferred or copied between users. A viral offer may be in the form of an electronic coupon, and may be redeemed directly at the store location or website of the merchant associated with the offer.

As used herein, a “viral offer program” can refer to program offered by a merchant or issuer that allows enrolled users to transfer or copy viral offers subject to merchant or issuer-defined restrictions.

As used herein, a “viral offer server computer” can refer to a server computer that performs functions related to the operation of a viral offer program. As described below, a server computer can be a powerful computer or cluster of computers. For example, a server computer can be a large mainframe, a minicomputer cluster, or a group of servers functioning as a unit. A server computer may also be a database server coupled to a Web server. The viral offer server computer may use a payment processing network to transmit and receive messages associated with viral offers. Additionally, the viral offer server computer may have access to a number of databases and may include a number of modules used for performing functions relating to the operation of a viral offer program.

As used herein, “transaction data” can include data contained in an authorization request message. For example, transaction data can include a transaction amount, a credit card or payment account number, cardholder or account holder information (name, date of birth, address, phone number, etc.), a card verification value, a bank identification number (BIN), expiration date, loyalty account information, etc. Additionally, transaction data may include viral offer data. For example, transaction data may include a viral offer identifier. The viral offer data can be contained in an authorization request message or in a standalone message.

As used herein, a “payment processing network” can include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transaction, and other types of commercial transactions. VisaNet™, in particular, includes a VIP system (Visa Integrated Payments system) which processes authorization requests and a Base II system which performs clearing and settlement services.

As used herein, a “viral offer record” can include a record that stores information relating to a viral offer. In particular, a viral offer record may include a velocity limit field, a viral offer chain, and other information.

As used herein, “viral offer data” can include data describing a viral offer. For example, viral offer data can include a viral offer identifier.

As used herein, a “velocity limit” can include a limit on the number of times a viral offer can be redeemed. A velocity limit may allow a provider of a viral offer program (e.g., a merchant or issuer) to limit the potential costs of the viral offer program. A velocity limit may allow the offer provider to deterministically define a maximum number of viral offers that can be redeemed during the lifetime of the viral offer program. A velocity limit can be a global limit on the total number of redemptions allowed across multiple users, or can be a limit applied in a more localized context. For example, a velocity limit can be tied to a specific user so that the number of redemptions is not disproportionately consumed by the user. Additionally, a velocity limit can be tied to a time period, so that the offer provider can gauge the success and costs of the viral offer program.

As used herein, a “viral offer chain” can define the path of a viral offer. As used herein, a “path” can refer to the sequence of users that a viral offer passes.

As used herein, a “relevancy filter” can limit the users that can receive viral offers to those users that are most relevant. For example, a relevancy filter can limit the users that can receive viral offers based on the users' transaction history, viral offer forwarding history, location, and third-party data.

As used herein, an “enrollment request” can include a message, from a user to a viral offer server computer, containing certain pieces of information allowing the user's participation in a viral offer program. For example, in an enrollment form supplied electronically to the user, the prospective user can provide information such as the telephone number of their mobile communication device, a financial account identifier, a security password, preferences regarding the types of viral offers that the user wishes to receive, and other information.

As used herein, a “settlement message” can include a message sent to an issuer and/or an acquirer including data describing the net financial position of the entities involved in a payment transaction.

As used herein, a “communication device” can include a mobile communication device such as a smart phone, smart card, cellular phones, personal digital assistant (PDAs), pager, smart media, transponders, tablet computers, and the like. A communication device can also include a personal computer, a laptop computer, a television, etc.

### I. Exemplary Viral Offer Systems

Embodiments of the invention are directed to the use of mobile communication devices, and methods and systems employing them.

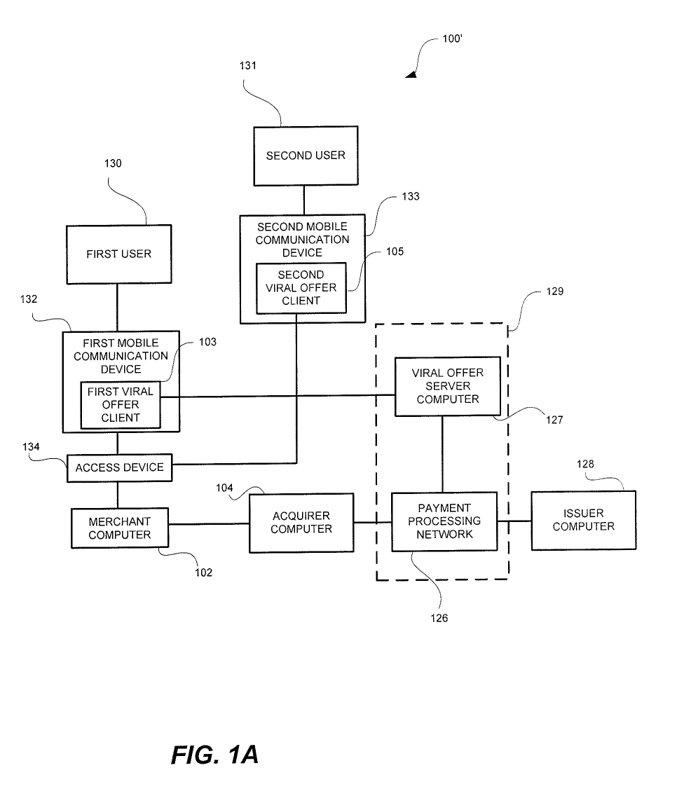

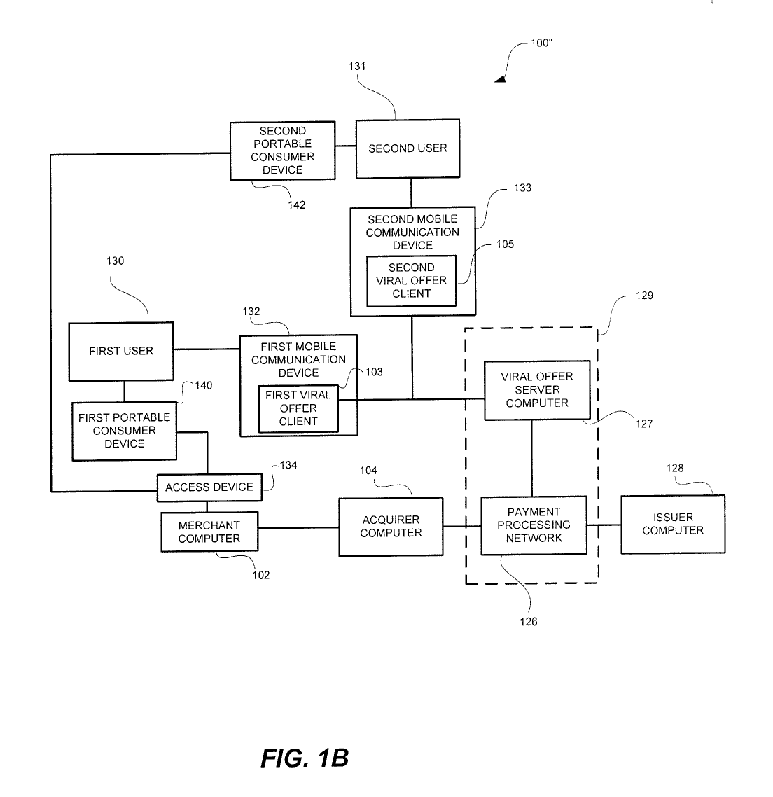

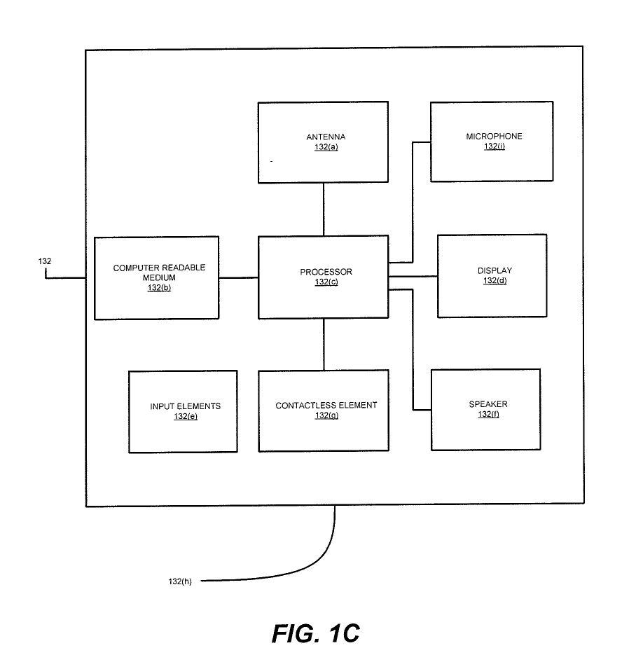

FIGS. 1A and 1B show viral offer systems 100′, 100″ that can be used in embodiments of the invention. Viral offer systems 100′, 100″ may include a merchant computer 102 and an acquirer computer 104 communicatively coupled to the merchant computer 102. In a typical payment transaction, a first user 130 may purchase goods or services at a merchant site associated with the merchant computer 102 using a first mobile communication device 132. The acquirer computer 104 can communicate with an issuer computer 128 via a payment processing network 126.

The acquirer computer 104 may be operated by a bank that has a merchant account. The issuer computer 128 may also be operated by a bank, but can also be operated by a business entity such as a retail store. Some entities are both acquirer computers and issuer computers, and embodiments of the invention may include such entities. The issuer computer 128 may operate as a server computer, which may have a computer readable medium comprising code for performing the functions that the issuer computer 128 performs. The issuer computer 128 may also store payment account information and other information.

The first user 130 and a second users 131 may be individuals, or organizations such as businesses that are capable of purchasing goods or services.

As seen in FIG. 1B, the first and second users 130, 131 may each be associated with a portable consumer device 140, 142 issued by an issuer. The portable consumer devices 140, 142 may be in any suitable form. Suitable portable consumer devices can be hand-held and compact so that they can fit into a user's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of portable devices include cellular phones, personal digital assistants (PDAs), pagers, payment cards, security cards, access cards, smart media, transponders, and the like. The portable devices can also be debit devices (e.g., a debit card), credit devices (e.g., a credit card), or stored value devices (e.g., a stored value card).

As seen in FIGS. 1A and 1B, the mobile communication devices 132, 133 may be in any suitable form. For example, suitable mobile communication devices can be hand-held and compact so that they can fit into a user's wallet and/or pocket (e.g., pocket-sized). They may include smart cards, cellular phones, personal digital assistants (PDAs), pagers, payment cards, smart media, transponders, tablet computers, and the like. The mobile communication devices 132, 133 can also include a payment application that facilitates debit, credit, or stored value transactions. The mobile communication devices 132, 133 may include viral offer clients 103, 105.

To illustrate, FIG. 1C shows an example of a mobile communication device, as may be used in various embodiments.

FIG. 1C is a block diagram showing mobile communication device 132 that can be used in embodiments of the invention. The mobile communication device 132 can be both a notification device that can receive viral offers, as well as a portable device that can be used to make payments. The exemplary mobile communication device 132 may comprise a computer readable medium 132(b) and a body 132(h). The computer readable medium 132(b) may be present within the body 132(h), or may be detachable from it. The body 132(h) may be in the form of a plastic substrate, housing, or other structure. The computer readable medium 132(b) may be in the form of (or may be included in) a memory that stores data (e.g., issuer account numbers, loyalty provider account numbers, etc.) and may be in any suitable form including a magnetic stripe, a memory chip, etc. The memory preferably stores information such as financial information, transit information (e.g., as in a subway or train pass), access information (e.g., as in access badges), etc. Financial information may include information such as bank account information, loyalty account information (e.g., a loyalty account number), a bank identification number (BIN), credit or debit card number information, account balance information, expiration date, user information such as name, date of birth, etc. Any of this information may be transmitted by the mobile communication device 132.

In some embodiments, information in the memory may also be in the form of data tracks that are traditionally associated with credit cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks abide by it. It contains the cardholder's account, encrypted PIN, plus other discretionary data.

The mobile communication device 132 may further include a contactless element 132(g), which may typically be implemented in the form of a semiconductor chip (or other data storage element) with an associated wireless transfer (e.g., data transmission) element, such as an antenna. Contactless element 132(g) may be associated with (e.g., embedded within) mobile communication device 132 and data or control instructions transmitted via a cellular network may be applied to contactless element 132(g) by means of a contactless element interface (not shown). The contactless element interface functions to permit the exchange of data and/or control instructions between the mobile device circuitry (and hence the cellular network) and an optional contactless element 132(g).

Contactless element 132(g) may be capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the mobile communication device 132 and an interrogation device. Thus, the mobile communication device 132 may be capable of communicating and transferring data and/or control instructions via both cellular network and near field communications capability.

The mobile communication device 132 may also include a processor 132(c) (e.g., a microprocessor) for processing the functions of the mobile communication device 132 and a display 132(d) to allow a user to see phone numbers and other information and messages. The mobile communication device 132 may further include input elements 132(e) to allow a user to input information into the device, a speaker 132(f) to allow the user to hear voice communication, music, etc., and a microphone 132(i) to allow the user to transmit her voice through the mobile communication device 132. The mobile communication device 132 may also include an antenna 132(a) for wireless data transfer (e.g., data transmission).

A communication device may be associated with a first user, and may comprise a processor, and a computer readable medium coupled to the processor, wherein the computer readable medium comprises code executable by the processor for implementing a method comprising: sending an enrollment request message to a viral offer server computer, wherein the enrollment request message associates the first user with a financial account, receiving a viral offer, and forwarding the viral offer to a communication device associated with a second user.

A communication device may also comprise a processor, and a computer readable medium coupled to the processor, wherein the computer readable medium comprises code executable by the processor for implementing a method comprising: receiving a viral offer, and interacting with an access device to conduct a transaction, wherein conducting the transaction comprises sending transaction data to the access device, and wherein the access device is configured to generate and send an authorization request message comprising the transaction data to a viral offer server computer configured to: receive the authorization request message, after receiving the authorization request message, accessing a viral offer record associated with the viral offer, wherein the viral offer record includes a velocity limit, and if the velocity limit has not been met, updating the velocity limit.

Returning to FIGS. 1A and 1B, the payment processing network 126 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The payment processing network 126 may operate as a server computer. A server computer is typically a powerful computer or cluster of computers. For example, the server computer can be a large mainframe, a minicomputer cluster, or a group of servers functioning as a unit. In one example, the server computer may be a database server coupled to a Web server. The payment processing network 126 may use any suitable wired or wireless network, including the Internet.

The merchant computer 102 may also have, or may receive communications from, an access device 134 that can interact with the mobile communication device 132. In an embodiment of a system of FIG. 1, the access device 134 is located at a merchant site that houses the merchant computer 102. However, it could be located at any other suitable location in other embodiments of the invention.

The access device 134 according to embodiments of the invention can be in any suitable form. Examples of access devices include point of sale (POS) devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like.

While not shown in FIGS. 1A and 1B for simplicity of discussion, if the access device 134 is a point of sale terminal, any suitable point of sale terminal may include a reader, a processor, and a computer readable medium. The reader may include any suitable contact or contactless mode of operation. For example, exemplary card readers can include RF (radio frequency) antennas, magnetic stripe readers, etc. to interact with the mobile communication device 132.

In a typical purchase transaction, the first user 130 purchases a good or service through the merchant computer 102 using a portable consumer device 140 or a mobile communication device 132 such as a cellular phone. The first user's mobile communication device 132 can interact with an access device 134 such as a POS (point of sale) terminal communicatively coupled to the merchant computer 102. For example, the POS terminal may be a contactless reader, and the mobile communication device 132 may be a contactless device. In certain embodiments, the mobile communication device may be a mobile communication device such as shown in FIG. 1C above. As described in detail below, the antenna of the mobile communication device may be utilized to communicate not only financial information to the POS, but may also communicate viral offer information (such as a code) relating to a viral offer to a POS device.

The access device 134 may then send an authorization request message to the merchant computer 102 for forwarding to the acquirer computer 104. After receiving the authorization request message, the authorization request message may then be sent by the acquirer computer 104 to the payment processing network 126. The payment processing network 126 may then forward the authorization request message to the issuer computer 128 associated with the issuer of mobile communication device 132.

After the issuer computer 128 receives the authorization request message, the issuer computer 128 may send an authorization response message back to the payment processing network 126 to indicate whether the current transaction is authorized (or not authorized). The payment processing network 126 may then forward the authorization response message back to the acquirer computer 104. The acquirer computer 104 may then send the response message back to the merchant computer 102.

After the merchant computer 102 receives the authorization response message, the access device 134 at the merchant site may then provide the authorization response message for the user 130. The response message may be displayed by the access device 134, or may be printed out on a receipt.

At the end of the day, a normal clearing and settlement process can be conducted by the payment processing network 126. A clearing process is a process of exchanging financial details between and acquirer computer and an issuer computer to facilitate posting to a user's account and reconciliation of the user's settlement position.

The payment processing network 126 may be communicatively coupled to a viral offer server computer 127. The viral offer server computer 127 may perform functions related to the operation of a viral offers program. For example, the viral offer server computer 127 may comprise a server computer including a processor, and a computer readable medium coupled to the processor, wherein the computer readable medium comprises code executable by the processor for implementing a method comprising: sending a viral offer to a mobile communication device associated with a first user, wherein the first user is enrolled with a viral offer program operated by a viral offer server computer, receiving an authorization request message for a transaction conducted by a second user, after receiving the authorization request message, accessing a viral offer record associated with the viral offer, wherein the viral offer record includes a velocity limit, and if the velocity limit has not been met, updating the velocity limit. In some embodiments, the viral offer server computer 127 operates separately and independently from the payment processing network 126, while in other embodiments the viral offer server computer and the payment processing network 126 are incorporated in a server, as shown by the dotted box 129.

As shown in FIGS. 1A and 1B, the viral offer server computer 127 may also be communicatively coupled to a first viral offer client 103 and a second viral offer client 105 running on the first mobile communication device 132 and the second mobile communication device 133, respectively. A viral offer client can be a module that allows mobile communication devices to transfer and manage viral offers. In some embodiments, a viral offer may be an application that the user downloads onto their mobile communication device. Such applications can be provided by the payment processing network or the issuer. In embodiments, the viral offer client may be an SMS or email client that is offered by a third party, the provider of the mobile communication device, and/or a social networking platform.

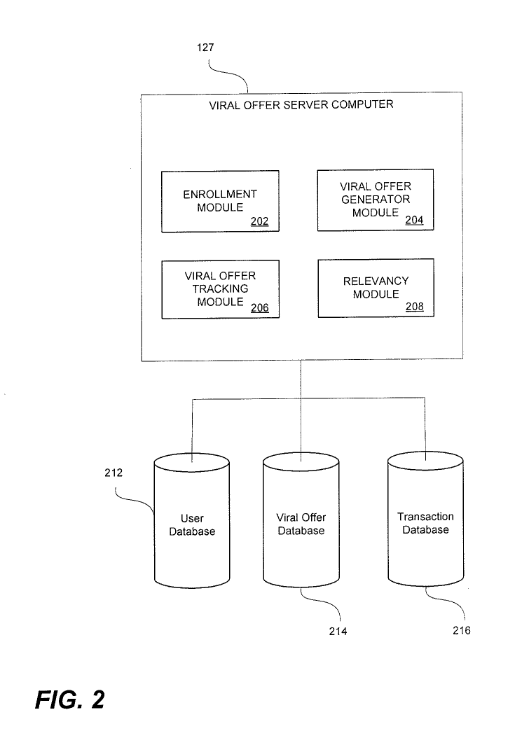

With reference to FIG. 2, an expanded view of the viral offer server computer 127 is shown. The viral offer server computer 127 may include an enrollment module 202, a viral offer generator module 204, a viral offer tracking module 206, and a relevancy module 208.

Enrollment module 202 may provide an interface for potential users to enroll in a viral offer program. Enrollment module 206 may be configured to receive from potential users certain pieces of information allowing their participation in the viral offer program. For example, in an enrollment form supplied electronically to the user, the user can provide information such as the telephone number of their mobile communication device, an alias, an e-mail address, a financial account identifier, a security password, preferences regarding the types of viral offers that they wish to receive, and other information.

The viral offer generator module 204 may generate viral offers based on a number of factors. For example, a viral offer can be generated based on a triggering condition defined, for example, by a merchant or issuer sponsoring the viral offer program. In another example, the viral offer generator module 204 can generate an offer based on a first user requesting the viral offer server computer 127 to forward a viral coupon to a second user, as further described below. When the viral offer generator module 204 generates a viral offer, the viral offer generator module 204 may perform operations that associate the generated viral offer with the user. For example, the viral offer generator module 204 may store a viral offer record identifier in a user record associated with the user receiving the viral offer.

The viral offer tracking module 206 can track how a viral offer is forwarded from one user to another. For example, as described below, the offer tracking module 206 may maintain a dependency graph to prevent the first user from forwarding a copy of the viral offer to a second user when the second user has already received the viral offer. In some embodiments, the dependency graph can also be used to award reward points to users that have sent viral offers to other users that ultimately redeem the viral offer.

The relevancy module 208 may use a relevancy filter to return a list of relevant users. The relevancy filter can be used to identify a set of users that are relevant to the merchant or issuer conducting the viral offer campaign. The relevancy filter can also be used to identify a set of users that are interested in receiving the viral offer. The relevancy filter is further described below.

The viral offer server computer 127 may be a server computer that executes the various modules. As described above, a server computer is typically a powerful computer or cluster of computers. For example, the server computer can be a large mainframe, a minicomputer cluster, or a group of servers functioning as a unit. In one example, the server computer may be a database server coupled to a Web server. The viral offer server computer 127 may use the payment processing network 180 to transmit and receive viral offer messages. As described herein, the viral offer server computer 127 may also be contained within the payment process network 180.

The viral offer server computer 127 may also have access to a number of databases. In particular, the viral offer server 127 may have access to a user database 212 to store information regarding a user's involvement in the viral offer program, a viral offer database 214 to store viral offer criteria and attributes, and a transaction database 216 to store transaction data received from the payment processing network 126.

Some of the embodiments described below may use a viral offer system like the one described above, or any suitable combination of components in the viral offer system.

### II. Exemplary Viral Offers

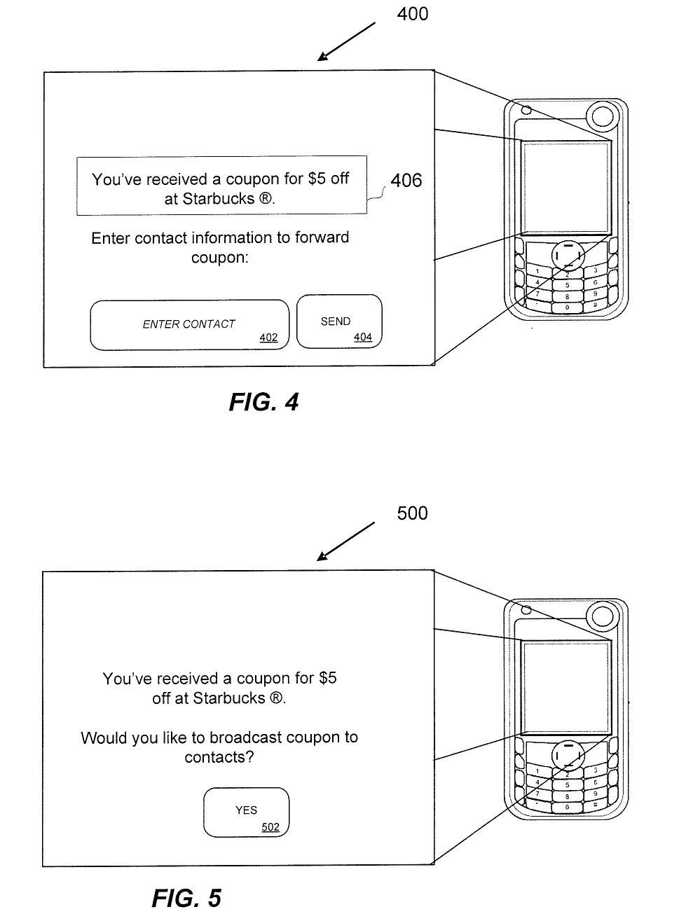

FIGS. 4 and 5 are screenshots 400, 500 showing graphical examples of two viral offers in different forms, as may be received and forwarded by users using viral offer clients running on their mobile communication devices. Although screenshots 400, 500 are configured to be able to be displayed on a small screen of a mobile communication device, such as a mobile phone, personal digital assistant (PDA), or any other suitable mobile communication device, it is to be appreciated that screen shots 400, 500 can also be configured to be displayed on larger screens such as desktop computers, laptops, televisions, etc.

FIG. 4 is a screenshot of a viral offer 400 that allows the first user 130 to forward the viral offer to a second user 131. As shown in FIG. 4, the viral offer 400 may display an offer description 406 to inform the user of the benefit provided by the viral offer. The viral offer 400 can also include a contact field 402 to enter a contact address and a submit button 404. When the user enters contact information (e.g., a phone number, e-mail address, or other alias) in the contact field 402, selecting the submit button 404 can cause the viral offer 400 to be forwarded to the second user identified in the contact field 402. The forwarding of viral offers from the first user 130 to the second user 131 is described in further detail below. user

FIG. 5 illustrates a screenshot showing a different embodiment of a viral offer 500 in accordance with the present invention. Instead of allowing the first user 130 to forward the viral offer to a contact (as shown in FIG. 4), viral offer 500 may include a post button 502 that allows the first user 130 to post the viral offer to a social platform, for example. A “social platform,” as used herein, can refer to any suitable platform that multiple users join and can interactively communicate with each other. Social platforms typically provide a user with the ability to create accounts, post pictures or other images, send public and/or private messages to other members of the platform, create relationships (e.g., friendships or business networks) and other various activities. Social platforms also typically provide application program interfaces (APIs) to allow external modules to communicate with the social platform. LINKEDIN®, FACEBOOK®, and TWITTER® are examples of popular social platforms currently available. The first user 130 can submit the viral offer to the social platform by selecting the post button 502.

### III. Exemplary Viral Offers Methods

Example embodiments of the present invention relate to methods and apparatuses which allow distribution, sharing, and/or redemption of viral offers using a mobile communication device. Various embodiments of such a system are described in the following figures.

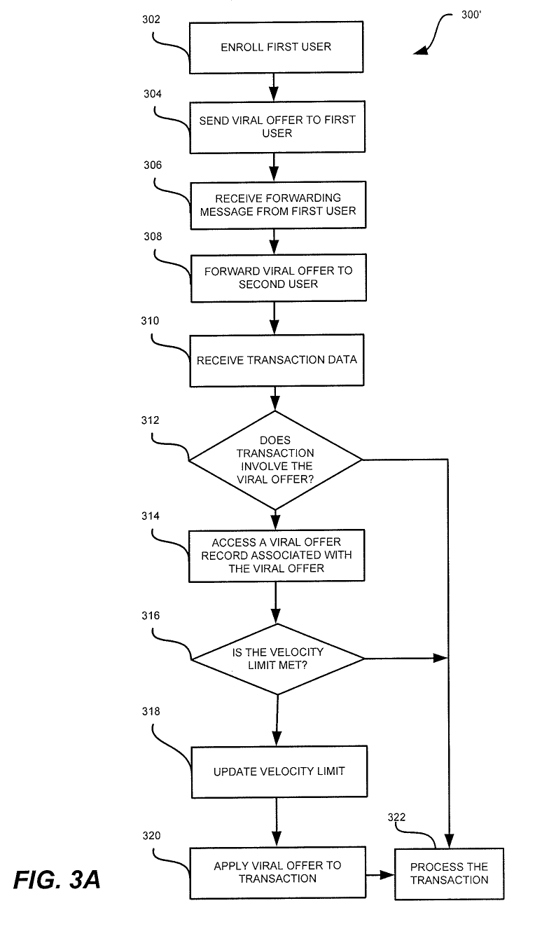

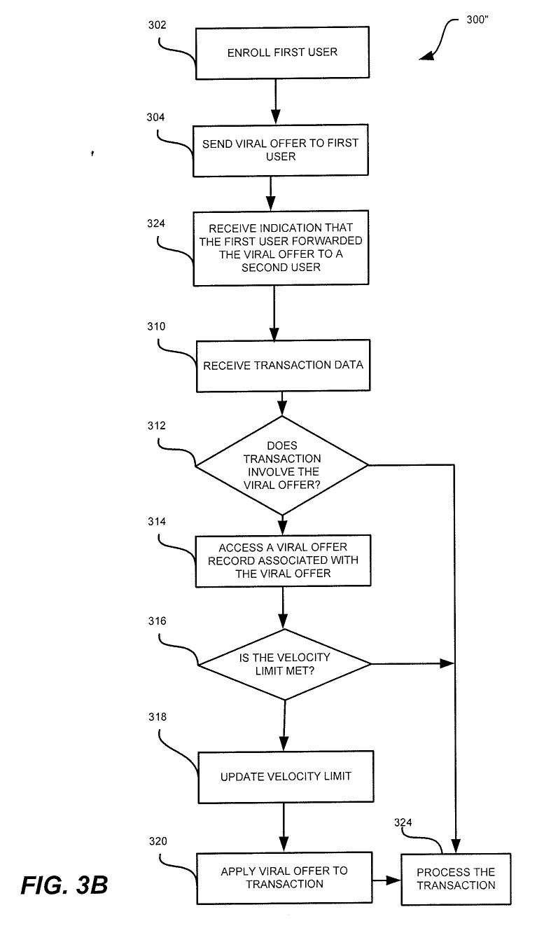

FIG. 3A is a flow chart showing a simplified method 300 for tracking a viral offer, according to an example embodiment.

In step 302, a user enrolls with a viral offer program operated by the viral offer server computer 127. For example, the user can navigate to the enrollment website of the viral offer server computer 127 utilizing a web browser on a mobile communication device. Upon visiting the enrollment website of the viral offer server computer 127, the user can select a link or button causing an enrollment request message to be sent from the mobile communication device to the viral offer server computer 127 indicating that the user requests to enroll in the viral offer program. After receiving the enrollment request message, the viral offer server computer 127 can request the user to submit identification and validation information by sending a validation request message to the mobile communication device. Examples of such requested identification information include the user's name, the telephone number of the user's mobile communication device, an e-mail address, financial account identifiers, and optional aliases. The enrollment module 202 can also send a validation request message to the mobile communication device to verify that the user has read the appropriate disclaimers and affirmatively indicate that they seek to opt-in to the viral offer program. Throughout the enrollment process, messages passed between the mobile communication device and viral offer server computer 127 can be in any suitable electronic form, including SMS, e-mail, or any other suitable mode of communication over the Internet, a cellular network, or other wireless network.

Identification and validation information entered by the user can be sent as a validation response message from the mobile communication device to the viral offer server computer 127 and then verified by the enrollment module 202. Examples of such verification include confirming that the user identified is actually in possession of the mobile communication device, that the mobile communication device belongs to the user, and that any identified financial account belongs to the user. The enrollment module 202 can confirm that an identified financial account belongs to the user by requesting confirmation from an issuer computer 128. For example, the enrollment module 202 can send a financial account verification request message to the issuer computer 128 over the Internet or any other suitable channel for exchanging electronic information. In turn, the issuer computer 128 can search a financial account database maintained by the issuer to confirm that the enrollment information is accurate by matching the financial account and identification information provided by the user with information stored on the financial account database. The issuer computer 128 can then send a financial account verification response message back to the enrollment module 202 indicating whether or not the financial account of the user has been verified.

Verifying enrollment based on a financial account associated with an issuer has a number of advantages. For example, as compared to traditional verification processes that verify a working email, verifying a financial account is a comparatively trusted source of verification. Such is the case because, unlike creating a new email address, opening a financial account is relatively difficult. Thus, it is unlikely that a user would open a financial account just to obtain an additional viral offer account. Further, the viral offer server computer 127 can leverage the verification process used by the issuer.

Once the enrollment information for the user is verified, the enrollment module 202 can create a user record in the user database 212. The enrollment module 202 can also store the enrollment information in the user record. For example, the user record can be used to associate the user with the wireless phone number, financial account identifiers, e-mail address, potential aliases, etc. When a user record is created, the enrollment module 202 may assign a user record identifier to the user record. The user record identifier can uniquely identify a user record.

According to step 304, a viral offer may then be sent to the first viral offer client 103 of the first mobile communication device 132 associated with the first user 130. The viral offer may be sent by the viral offer server computer 127 utilizing any one of several types of communications methods. For example, the viral offer server computer 127 may send the viral offer to the first user 130 as an SMS message, an E-mail message, or any other suitable mode of communication over the Internet, a cellular network, or other wireless network.

Upon sending the viral offer to the first user 130, the viral offer generator module 204 can update the user record associated with the first user 130 to link the user record to the viral offer record associated with the viral offer sent to the first user 130. This linking is described in greater detail below.

Once the first user 130 receives a viral offer (e.g., those shown in FIGS. 4-5) on the first mobile communication device 132, the first user 130 can forward the viral offer to the second user 131. Embodiments can allow the first user 130 to forward a viral offer to the second user 131 according to any suitable technique, as is described below. For example, in one embodiment, the first viral client 103 may provide functionality to forward a viral offer message to a contact. To illustrate, the first user 130 may instantiate the viral offer client 103 on the first mobile communication device 132, and then enter the contact information of the second user 131 in a contact field 402 (with reference to FIG. 4) and then select the submit button 404. In another embodiment, the viral offer may include embedded instructions that cause the viral offer to be forwarded to the second user 131. For example, the viral offer 400 may include HTML, JavaScript, a plug-in, or any other software code that causes the viral offer to be forwarded to the second user 131.

In an embodiment, a forwarding request message containing the contact information for the second user 131 can be transmitted from the first viral offer client 103 to the viral offer server computer 127. This is shown as step 306. Upon receipt, the viral offer generator module 204 can forward the viral offer to the second viral offer client 105 of the second mobile communication device 133 associated with the second user 131. This is shown as step 308. The viral offer may be forwarded to the second user 131 utilizing any one of several types of communications methods. For example, the viral offer generator module 204 can send the viral offer to the second viral offer client 105 utilizing an SMS message, an E-mail message, or any other suitable mode of communication over the Internet, a cellular network, or other wireless network.

In an embodiment, prior to forwarding of the viral offer to the second user 131 (step 308), the viral offer server computer 127 can first perform enrollment verification steps to determine whether the second user is enrolled in the viral offer program. For example, the viral offer server computer 127 can attempt to match the contact information of the second user 131 with a user record contained in the user database 212. If a user record for the second user 131 exists, the viral offer server computer can update the user record to link it to the viral offer record associated with the viral offer. The viral offer can then be forwarded to the second user 131 (step 308). If no matching user record is found (e.g., if the second user 131 is not enrolled in the viral offer program), the enrollment module 202 can send a validation request message (not shown) to the second user 131 requesting identification and validation information for enrollment. The enrollment process for the second user 131 may involve the same steps as described above for the enrollment of the first user 130. Once enrolled in the viral offer program, the viral offer server computer can create a user record for the second user 131, link the user record to the viral offer record associated with the viral offer, and forward the viral offer (step 308) to the second mobile communication device 133 associated with the second user 131.

In another embodiment, as seen in FIG. 3B, the first user 130 can forward the viral offer to the second user 131 directly (e.g., without using the viral offer server computer 127 to forward the viral offer. For example, the first user 130 may forward the viral offer to the second user 131 using a SMS or any other point to point technology. In this embodiment, the viral offer server computer 127 may receive an indication that the viral offer has been forwarded. This is shown as step 324. The indication may be in the form of an SMS message, an e-mail message, or utilizing any other mode of communication over the Internet, a cellular network, or other wireless network. The indication may be sent by the first mobile communication device 132 upon transmission of the viral offer, or the second mobile communication device 133 upon receipt of the viral offer. Once the indication is received, the viral offer server computer 127 may perform the enrollment verification steps described above and link the user record associated with the second user 131 to the viral offer record associated with the viral offer. Alternatively, the viral offer server computer may perform the enrollment verification steps at a later time as described below.

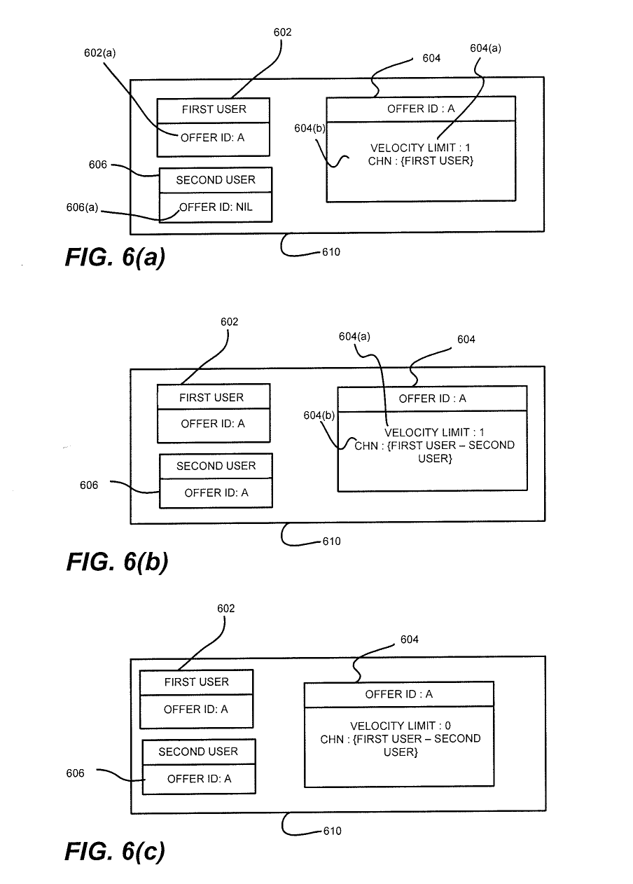

The viral offer tracking module 206 of the viral offer server computer 127 may track various measurements related to the viral offer during the lifecycle of a viral offer. For example, the viral offer tracking module 206 may track the users who have received the viral offer. FIGS. 6(a)-(c) are diagrams that show records for tracking a viral offer over time, according to an example embodiment.

In particular, FIG. 6(a) shows a records database 610 that may store user records 602, 606 and an offer record 604. FIG. 6(a) may relate to a first point in time, such as when the first user 130 receives the viral offer from the viral offer server computer 127 in step 304. Although FIG. 6(a) shows that the records 602, 604, 606 are stored in records database 610, it is to be appreciated that any combination of databases shown in FIG. 2 (e.g., 212, 214, and 216) may be used to store these records.

User record 602 is a record that may store information relating to the first user 130. As shown in FIG. 6(a), the user record 602 may include an viral offer identifier field 602(a). The viral offer identifier field 602(a) may link a user to a viral offer that is redeemable by the user. In the case of FIG. 6(a) the viral offer identifier field 602(a) may store the value ‘A’. Thus, the viral offer identifier field 602(a) can link the first user 130 to a viral offer with a viral offer identifier that matches the value ‘A’.

User record 606 is a record that may store information relating to the second user 131. Similar to user record 602, user record 606 may also include a viral offer identifier field 606(a). However, in comparison to user record 602, the viral offer identifier field 606(a) does not store an viral offer identifier, as is identified by the NIL value. Thus, the viral offer identifier field 606(a) does not link the second user 131 to a viral offer. This indicates that the second user 131 has not received any viral offers.

Viral offer record 604 may be a record that stores information relating to a viral offer. In particular, the viral offer record 604 may include a velocity limit field 604(a) and a viral offer chain 604(b).

The velocity limit field 604(a) may allow a provider or administrator of a viral offer program (e.g., a merchant or issuer) to limit the potential costs of a viral offer program. In particular, the velocity limit may allow the viral offer provider to deterministically define a maximum number of viral offers that can be redeemed during the lifetime of a viral offer program. Although the velocity limit field 604(a) is described herein as a global number that limits the total number of redemptions allowed across multiple users, it is to be understood that a velocity limit can be applied in a more localized context. For example, in some embodiments, a velocity limit can be tied to a specific user so that the number of redemptions is not disproportionately consumed by one or more users. Additionally, it is to be understood that the velocity limit can be tied to a time period, so that the viral offer provider can gauge the success and costs of the viral offer program.

The viral offer chain field 604(b) may define the path of the viral offer. As used herein, a “path” can refer to the sequence of users that a viral offer passes. Specific structures of a viral offer chain field 604(b) is described in greater detail below. According to FIG. 6(a), the viral offer chain field 604(b) indicates that only the first user has received the viral offer.

Whereas FIG. 6(a) shows the state of records 602, 604, and 606 after step 304 of FIG. 3, FIG. 6(b) shows the state of records 602, 604, 606 after step 306 of FIG. 3. In particular, FIG. 6(b) shows the records, 602, 604, and 606 after the first user 130 forwards the viral offer to a second user 131. Compared to FIG. 6(a), the user record 606 now links the second user 131 with the viral offer represented by viral offer record 604. This is shown in FIG. 6(b) by the viral offer identifier field 606(a) being set to the viral identifier ‘A’. Further, the viral offer chain field 604(b) of the viral offer record 604 is updated to show that the first user 130 has forwarded the viral offer to the second user 131.

With reference back to FIGS. 3A and 3B, and FIGS. 1A and 1B, after the first user 130 has forwarded the viral offer to the second user 131, the viral offer server computer 127 may receive transaction data involving the viral offer from the payment processing network 126. This is shown as step 308. For example, a user (e.g., either the first user 130 or the second user 131) may conduct a transaction at a merchant by swiping a portable consumer device such as a payment card at an access device 134 of the merchant. Alternatively, the access device 134 may be a contactless POS terminal, and the user may conduct the transaction with the merchant contactlessly using a mobile communication device. In such embodiments, an authorization request message may be transmitted from the access device 134 to a merchant computer 102 for forwarding to an acquirer computer 104. The acquirer computer 104 may then forward the authorization request message to the payment processing network 126. The authorization request message may include transaction data stored on the mobile communication device or the portable consumer device. The transaction data may include financial information such as a transaction amount, a credit card or payment account number, cardholder or account holder information (name, date of birth, address, phone number, etc.), a card verification value, a bank identification number (BIN), expiration date, loyalty account information, merchant information, etc. Additionally, the authorization request message may include transaction data such as viral offer data. For example, the transaction data may include a viral offer identifier.

In the embodiments described above, viral offer data may be contained in the authorization request message transmitted from the access device 134. If the transaction is contactless and conducted with a mobile communication device (as seen in FIG. 1A), the viral offer data may be stored on and transmitted from the mobile communication device. For example, if the second user 131 attempts to redeem the viral offer using the second mobile communication device 133, the second viral offer client 105 may transmit the viral offer data to the access device 134 for forwarding to the merchant computer 102, and then to the payment processing network 126.

If the transaction is conducted with a portable consumer device (as seen in FIG. 1B), however, additional steps may need to be performed before the viral offer can be redeemed. In some embodiments, the merchant may have access to a viral offer program database (not shown) including data tables storing information about the merchant's viral offers, user payment account numbers, and identification information for the users associated with the payment account numbers. For example, if the second user 131 attempts to redeem the viral offer using the second portable consumer device 142 at the access device 134, the access device 134 may transmit the financial information described above to the merchant computer 102. The merchant computer 102 may then access the viral offer program database to determine if the payment account number contained in the financial information is associated with the viral offer (e.g., if the first user 130 forwarded the viral offer to the second mobile communication device 133 associated with the second user 131). If the payment account number is associated with the viral offer, the merchant computer 102 may then include the viral offer data in the authorization request message sent to the acquirer computer 104.

The viral offer program database can be part of the merchant computer 102, the acquirer computer 104, the payment processing network 126, or other entity. The viral offer program database may also be the same as the viral offer database 214 (see FIG. 2) associated with the viral offer server computer 127. The data tables included in the viral off program database can be populated in a number of different ways and by a number of different entities. For example, the merchant may require participants in its viral offer program to register their mobile communication device, portable consumer device, and identification information. Once the second user 131 is registered and upon forwarding of the viral offer by the first user 130 to the second mobile communication device 133 associated with the second user 131, the viral offer server computer 127 can update the tables in the viral offer program database to associate the second user's payment account number with the viral offer. Alternatively, if the viral offer program database is maintained by the merchant, the viral offer server computer 127 can send a message to the merchant computer 102 indicating that the second user's payment account number should be associated with the viral offer. The merchant computer 102 can then update the tables in the viral offer program database to reflect the association.

In the embodiments described above, the transaction data contained in the authorization response message may include the viral offer data. Alternatively, the viral offer data may be communicated prior to, or following, communication between the payment card or mobile communication device and the access device 134 of the merchant. Still further, in some embodiments, some portion of the viral offer data may be transmitted to the viral offer server computer 127 using over the air transmission, such as a cellular network, the Internet, or other wireless network.

Upon receiving the authorization request message including the transaction data, the payment processing network 126 may route the authorization request message to the viral offer server computer 127. Alternatively, if the viral offer server computer 127 is the same entity as the payment processing network 126, the viral offer server computer 127 may receive the transaction data directly from the acquirer computer 104, merchant computer 102, or access device 134.

When the viral offer server computer 127 receives the authorization request message, the viral offer server computer 127 can determine whether the transaction involves a viral offer. This is shown as decision block 312. In an example embodiment, the viral offer server computer 127 can process portions of the received authorization request message. For example, in some embodiments, the authorization request message may store viral offer data in a field of the message. A viral offer identifier is an example of viral offer data that may be stored in the authorization request message to indicate that a viral offer is involved in the transaction. In alternate embodiments discussed above, the viral offer server computer may receive the viral offer data using over the air transmission by the mobile communication device. If the transaction involves a viral offer, step 314 is performed. Otherwise, step 322 is performed.

In another embodiment, the transaction data contained in the authorization response message may include no viral offer data. Instead, the viral offer server computer 127 may have access to one or more database with data tables including viral offer data, user payment account numbers, and identification information for the users associated with the payment account numbers. For example, a merchant or issuer conducting a viral offer program may register with the viral offer system and provide viral offer data to the viral offer server 127. Additionally, a user may register with the viral offer system to provide a payment account number, information about the user's communication device, and other identification information. In an embodiment, the viral offer data, user payment account numbers, and identification information for the user may be stored on the user database 212 and the viral offer database 214. When the viral offer server 127 receives an authorization request message containing the payment account number and merchant information, the viral offer server computer 127 can match the information with the data tables stored on the user database 212 and viral offer database 214 to determine whether the transaction involves a viral offer. If the transaction involves a viral offer, step 314 is performed. Otherwise, step 322 is performed.

According to step 314, the viral offer server computer 127 accesses a viral offer record associated with the viral offer being used in the transaction. In some embodiments, the viral offer server computer 127 can utilize the viral offer data to search the viral offer database 214 to identify information regarding the viral offer being redeemed by the user. For example, the transaction data may include a viral offer identifier that can be used to locate the viral offer record. With reference to FIG. 6(b), the transaction data may include a viral offer identifier with a value of ‘A’. The viral offer identifier ‘A’, according to FIG. 6(b), matches viral offer record 604.

In some embodiments, the viral offer server computer also verifies that the user is authorized to redeem the viral offer. For example, the viral offer server computer 127 may query the user database 212 to determine if the user is linked with the viral offer being redeemed. For example, the transaction data may include user specific data that the viral offer server computer 127 can use to locate the user record corresponding to the user making the purchase. For example, the transaction data can include a user identifier assigned to the user record or the primary account number (e.g., a credit card number or debit card number) used in the transaction. Once the user record is located, the viral offer server computer 127 can process the user record to determine if the user record includes a viral offer identifier field (e.g., see 602(a) of FIG. 6(a)) that matches the viral offer identifier of the viral offer being redeemed.

If the viral offer server computer 127 is unable to locate a user record associated with the user attempting to redeem the viral offer (e.g., the second user 131 is not enrolled in the viral offer program), then step 322 may be performed and the transaction may be processed without application of the viral offer, Alternatively, in some embodiments, the enrollment module 202 in the viral offer server computer 127 may send a validation request message (not shown) to the second user 131 requesting identification and validation information for enrollment. This validation request message may be sent to the second user 131 in the form of an SMS message, e-mail message, or utilizing any other suitable means of communication over the Internet, cellular network, or other wireless network. The enrollment process for the second user 131 may involve the same steps as described above for the enrollment of the first user 130. Once enrolled in the viral offer program, the viral offer server computer can create a user record for the second user 131, and link the user record to the viral offer record associated with the viral offer.

Once the viral offer record is accessed, and the viral offer server computer verifies that the user can redeem the viral offer, the viral offer server computer 127 then can determine if a velocity limit is met. This is shown as decision block 314. For example, the viral offer server computer 127 may process the accessed viral offer record to determine if the velocity limit field has reached a predetermined number. For example, FIG. 6(b) shows that the velocity limit field includes a value of ‘1’. In an example embodiment, a velocity limit is met when the value is ‘0’. In some embodiments, the velocity limit field may include a value of 5, 10, 15, or any other value. In other embodiments, the velocity limit is met based on any other suitable condition, such as a predefined number set by the viral offer provider. If the velocity limit has not been met, step 318 is performed. Otherwise, step 322 is performed.

Step 318 involves updating the velocity limit associated with the viral offer being redeemed. In this step, the viral offer may update the velocity limit to reflect that the viral offer is being redeemed by the user. For example, FIG. 6(c) shows the state of records 602, 604, 606 after step 316 of FIG. 3. In particular, FIG. 6(c) shows the records, 602, 604, and 606 after the second user 131 redeems the viral offer during a purchase transaction. Compared to FIGS. 6(a) and 6(b), the velocity limit field 604(a) of the viral offer record 604 has been updated to store the value of ‘0’. Further, the viral offer identifier field 606(a) of user field 606 can be updated (not shown) to indicate that the viral offer is no longer available. It is to be appreciated that updating the viral offer identifier field 606(a) is optional, as some embodiments may allow a user to redeem a single viral offer multiple times.

After the velocity limit is updated, the benefit associated with the viral offer may then be applied to the transaction. This is shown as step 320. Application of the benefit associated with the viral offer can occur in a number of different ways by the viral offer server 127, merchant, or issuer. In one embodiment, the viral offer server computer 127 may forward the authorization request message with the viral offer data to the issuer computer 128 for authorization of the transaction. After authorization and completion of the transaction, the issuer may then provide the user redeeming the viral offer with a statement credit reflecting the benefit of the viral offer. In another embodiment, the viral offer server computer may send a message to the merchant indicating that the merchant should apply the viral offer to the transaction. For example, after receiving an authorization response message indicating authorization of the transaction by the issuer, the viral offer server computer 127 may modify the authorization response message to indicate that the merchant should apply the benefit of the viral offer. The viral offer server computer 127 may then forward the modified authorization response message to the acquirer computer 104 for forwarding to the merchant computer 102. Upon receipt of the modified authorization response message, the merchant may apply the benefit of the viral offer. Alternatively, the viral offer server computer 127 may send a message, separate from the authorization response message, to the merchant indicating that the viral offer should be redeemed. This message can be sent to the acquirer computer 104 for forwarding to the merchant computer 102, or may be sent to the merchant via any other means of transmitting electronic information, including the Internet for example. In another embodiment, after determining that the viral offer is redeemable, the viral offer server computer 127 may modify the authorization request message to apply the benefit of the viral offer. The modified authorization request message may then be forwarded to the issuer computer 128. After receiving an authorization response message reflecting application of the benefit of the viral offer from the issuer computer 128, the viral offer server computer can then forward the authorization response message to the acquirer computer 104 for forwarding back to the merchant computer 102. The application of the benefit of the viral offer may cause, for example, a reduction in the dollar amount associated with the transaction being conducted by the user.

After step 320 or step 312, the payment processing network 126 may process the transaction. As described above, this may involve sending an authorization request message to the issuer computer 128. In this step, transaction data can be stored in the transaction database 216. The transaction database may link the user with details of the transaction. Details of processing a payment transaction are described above.

In some embodiments, after the viral offer is redeemed, the viral offer server computer 127 may trace the viral offer path stored in the user record to reward the users who forwarded the viral offer to users who ultimately redeemed the viral offer.

As described above, a viral offer can be forwarded from a first viral offer client 103 to a second viral offer client 105 through the viral offer server computer 127. This technique has the advantage of being able to track the path of the viral offer directly because the viral offer server computer 127 sits in between the two viral offer clients during the exchange. As also described above, a viral offer can be forwarded from a first viral offer client 103 to a second viral offer client 105 without utilizing the viral offer server computer 127 to forward the offer. To track the path of the viral offer, a message can be sent from either mobile communication device to the viral offer server computer 127 indicating that the transfer has occurred.

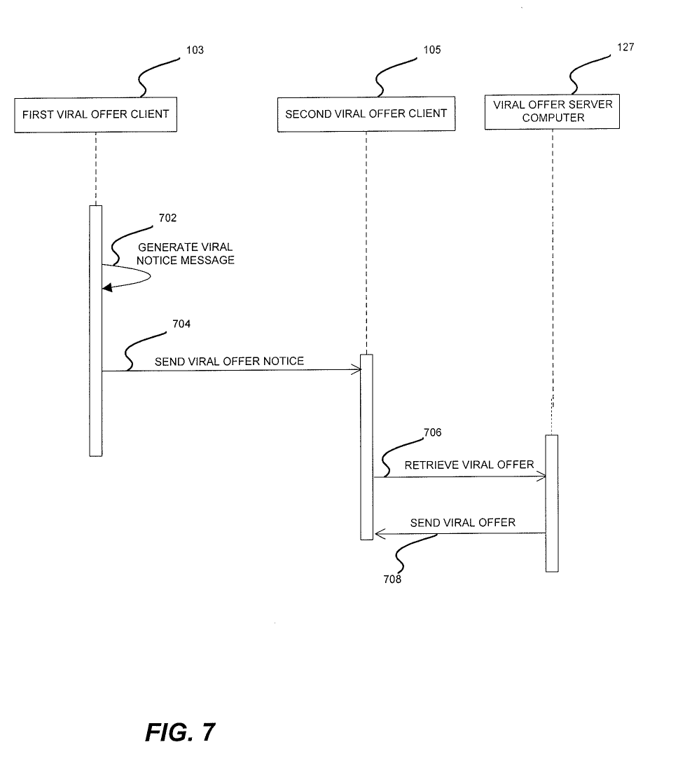

FIG. 7 is a sequence diagram that shows messages exchanged between a first viral offer client, second viral offer client, and viral offer server computer in another embodiment of the invention.

To begin, a user may interact with a viral offer displayed by the viral offer client running on the mobile communication device to cause the viral offer client to forward the viral offer to a second user. For example, the first user 130 may enter the contact information relating to the second user 131 in contact field 402 (see FIG. 4) and then may select the send field 404 (see FIG. 4). Selecting the send field 404 may cause the first viral offer client 103 to generate a viral notice message. This is shown as message 702 of FIG. 7. As used herein, a viral notice message can refer to a message that informs a user that a viral offer is available to them.

Once the viral notice message is generated, the first viral offer client 103 may send the viral notice message to the second viral offer client 105. This is shown as message 704. It is to be noted that in FIG. 7, the viral offer server computer 127 is not involved in sending the viral notice message 704. Such may be the case where the viral notice message is an SMS message, email message, social platform message, or any other suitable message.

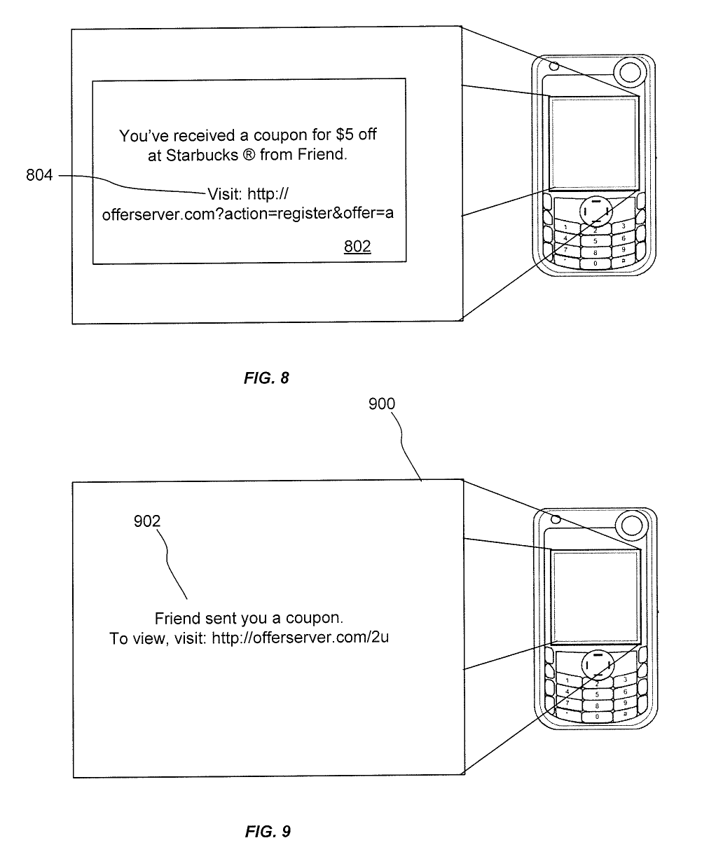

For the purpose of illustration, FIG. 8 is a diagram showing a screen shot of a viral notice message 800 that may be received by the second viral client 105. As shown in FIG. 8, the viral notice message 800 may include a notice description 802 that indicates that a viral offer is available to the second user 131. The viral message 800 also includes a link to the viral offer server computer 127. A uniform resource locator (URL) is an example of a link 804 to the viral offer server computer. It is to be noted that the link 804 may include embedded information that specifies to the viral offer server computer 127 to register the second user 131 with the viral offer corresponding to a specified viral offer identifier. Alternative to selecting the link 804, the viral notice message may include buttons that cause the second mobile communication device 133 to communicate with the viral offer server computer 127.

FIG. 9 is a diagram showing a screen shot of an alternative viral offer notice message 900 that may be received by the second viral offer client 105. In comparison to FIG. 8, the viral notice message 900 includes a shortened link 902, as may be provided by URL shortening service, such at TINYURL™.

As described above, selecting links of viral notice messages 800, 900, may cause the second viral offer client 105 to retrieve the viral offer from the viral offer server computer 127 by sending a viral offer request message 706 to the viral offer server computer 127. Viral offer request message 706 may include data stored in the viral notice message, such as a viral offer identifier and a first user identifier. Responsive to receiving the viral offer request message 706, the viral offer server computer 127 may verify that the first user 130 is linked with the viral offer and, if so, update the user record of the second user 131 to link the second user with the viral offer. Further, the viral offer server computer 127 may update the viral offer record to indicate that the first user 130 forwarded the viral offer to the second user 131. These updates may use the data received in the viral offer request message 706.

After updating the user record and the viral offer record, the viral offer server computer 127 may send the viral offer (e.g., as shown in FIGS. 4 and 5) to the second viral offer client 105 in the viral offer response message 708. Steps 310-322 in FIGS. 3A and 3B can then be performed by the viral offer server computer 127.

### IV. Relevancy Filter

Although traditional electronic offers can be forwarded across multiple users, such current approaches lack the ability to control the viral nature of offers to those user that are most relevant. In an example embodiment, the relevancy module 208 of the viral offer server computer 127 may limit the users that can receive the viral offers based on a relevancy filter.

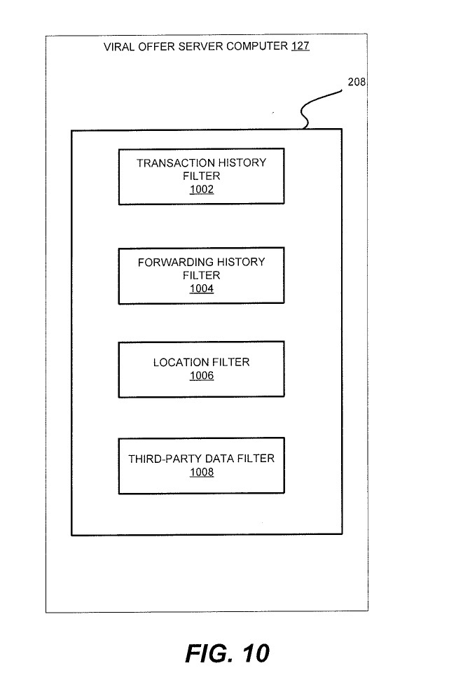

FIG. 10 shows the relevancy module 208 of the viral offer server computer 127 and the various filters that the relevancy module 208 may support. In particular, an example embodiment of the relevancy module 208 may support a relevancy filter based on a transaction history filter 1002, forwarding history filter 1004, location filter 1006, and third-party data filter 1008.

The transaction history filter 1002 is a relevancy filter that limits the forwarding of a viral offer based on transaction data that passes through the payment processing network. Such transaction data may be stored in the transaction database 216 shown in FIG. 2. The relevancy module 208 may only allow a user to forward a viral offer to users that have not conducted a transaction at a specific merchant store. Merchants may be specified according to a merchant verification value that is transmitted in an authorization request message, as may be inserted by a POS terminal. Alternatively, the transaction history filter 1004 may allow the relevancy module 108 to limit the available users that can receive the viral offer based on other factors, such as whether a user commonly shops at a category of merchants or a competitor merchant. The transaction history filter 1002 may allow for filtering based on other factors, such as the location of transactions, the time of transactions, the dollar amount of transactions, rate of declines, or any other suitable data found in a authorization request message or authorization response message. It is to be appreciated that such factors can be used in any combination. For example, transaction history filter 1004 can filter for users that have not purchased at a specific merchant but instead have made purchases above a determinable amount at merchants within the same category.

The forwarding history filter 1004 is a relevancy filter that limits the forwarding of a viral offer based on the forwarding history of a user. For example, the forwarding history filter 1004 may filter out users that have a low frequency of forwarding viral offers to other users. Further, the forwarding history filter 1004 may take into account the success of a user's forwards. For example, a user that forwards a viral offer that is ultimately redeemed may be considered more relevant than a user that forwards a viral offer that is not redeemed. In measuring the success of a user's forwards, the forwarding history filter 1004 may take into account the user's absolute number of redemptions or the ratio of redemptions to forwards.

The location filter 1006 may be a relevancy filter that limits the forwarding of a viral offer based on the location of a user. For example, the location filter 1006 may filter out users that are not currently located within a determinable distance from a merchant store or within a specified zip code. To provide location based filtering, a mobile communication device running a viral offer client may periodically transmit location information to the viral offer server computer 127. The location information may be determined using cellular triangulation, a Global Positioning System (GPS), POS Terminal Location, or any other suitable means of determining the location of the mobile communication device,

The third-party data filter 1010 may be a relevancy filter that limits the forwarding of a viral offer based on data from third-party sources. For example, in one embodiment, the viral offer client may receive information from a user's set-top box, such as the channels, programs, or any other information relating to the interaction between the user and the set-top box. For example, third-party data filter 1010 may determine that the user watched a commercial and then, within a determinable time, visited a specified web-site or television channel. Such an interaction can be evidence of a user's interest in a product, and the relevancy filter may limit the forwarding of a viral offer to those interested users.

Although the relevancy module 208 may be described in terms of filtering out users that may receive a viral offer, it is to be appreciated that the relevancy module 208 can similarly rank users based on the relevancy of the user. Further, the relevancy module 208 can filter out users that have already received a viral offer based on the viral path field on a particular viral offer. Still further, a user may set preferences based on the criteria of the viral offer, such as whether the viral offer is over a specified amount or for a particular product, whether the viral offer is sent through a specified channel (email, SMS text message, application PUSH, etc), or whether the user forwarding a viral offer is a friend or contact according to a social networking platform. Lastly, a user may set preferences regarding the number of offers they want to receive within a determinable period of time. Consequently, each viral offer may be assigned a priority value. For example, if a viral offer is assigned a low priority value, the relevancy module 208 may filter out those users who have set their preferences to receive only a small number of viral offers to ensure that these users receive only high priority viral offers.

### V. Exemplary Computer Apparatuses

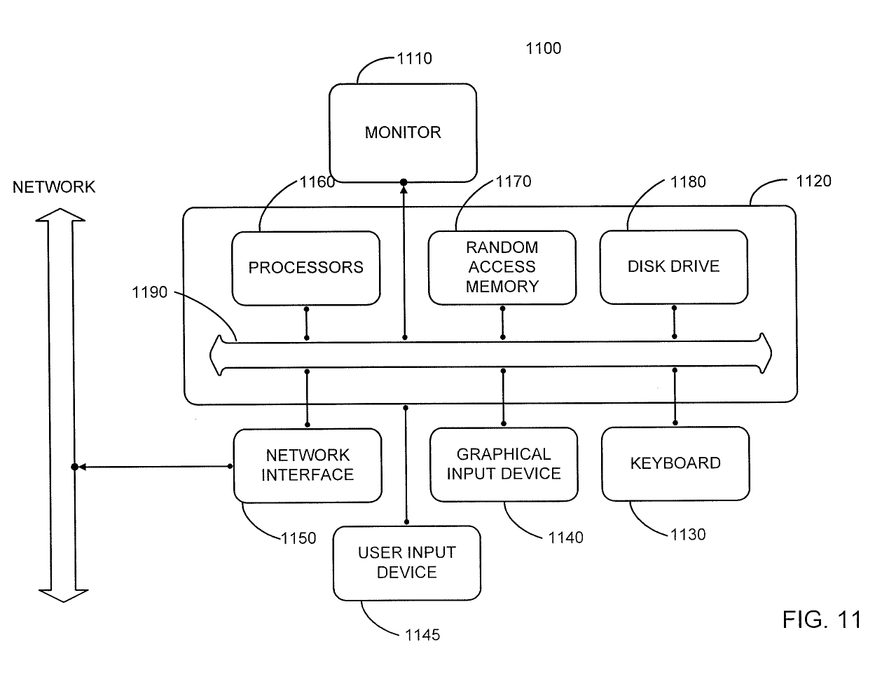

FIG. 11 shows a block diagram of an exemplary computer apparatus that can be used in some embodiments of the invention (e.g., in any of the components shown in the prior Figures).

Any of the elements in figures described herein can use any suitable number of subsystems to facilitate the functions described herein. System 1100 in FIG. 11 is representative of a computer system capable of embodying various aspects of the present invention. The computer system can be present in any of the elements in figures described herein, including viral offer server computer 127, for example. Similarly, the various participants, entities and elements in FIG. 1 may operate one or more computer apparatuses to facilitate the functions described herein. It will be readily apparent to one of ordinary skill in the art that many other hardware and software configurations are suitable for use with the present invention.

For example, the computer may be a desktop, portable, rack-mounted or tablet configuration. Additionally, the computer may be a series of networked computers. Further, the use of other micro processors are contemplated, such as Xeon™, Pentium™ or Core™ microprocessors; Turion™ 64, Opteron™ or Athlon™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board. Various embodiments may be based upon systems provided by daVinci, Pandora, Silicon Color, or other vendors.

In one embodiment, computer system 1100 may include a monitor 1110, computer 1120, keyboard 1130, user input device 1145, network interface 1150, and the like. In various embodiments, monitor 1110 may be embodied as a CRT display, LCD display, plasma display, direct-projection or rear-projection DLP, microdisplay, or the like. In various embodiments, display 1110 may be used to display user interfaces and rendered images.

In various embodiments, user input device 1145 may be embodied as a computer mouse, trackball, track pad, joystick, wireless remote, drawing tablet, voice command system, and the like. User input device 1145 may allow a user to select objects, icons, text and the like that appear on the display 1110 via a command such as a click of a button or the like. An additional specialized user input device 1145, such a magnetic stripe, RFID transceiver or smart card reader may also be provided in various embodiments. In other embodiments, user input device 1145 may include additional computer system displays (e.g. multiple monitors). Further user input device 1145 may be implemented as one or more graphical user interfaces on such a display.

Embodiments of network interface 1150 may include an Ethernet card, a modem (telephone, satellite, cable, ISDN), (asynchronous) digital subscriber line (DSL) unit, FireWire interface, USB interface, and the like. For example, network interface 1150 may be coupled to a computer network, to a FireWire bus, or the like. In other embodiments, network interface 1150 may be physically integrated on the motherboard of computer, may be a software program, such as soft DSL, or the like.

RAM 1170 and disk drive 1180 are examples of computer-readable tangible media configured to store data such user, account and transaction level data, calculated aggregated data, super keys, sub keys and other executable computer code, human readable code, or the like. Other types of tangible media include magnetic storage media such as floppy disks, networked hard disks, or removable hard disks; optical storage media such as CD-ROMS, DVDs, holographic memories, or bar codes; semiconductor media such as flash memories, read-only-memories (ROMS); battery-backed volatile memories; networked storage devices, and the like.

In the present embodiment, computer system 1100 may also include software that enables communications over a network such as the HTTP, TCP/IP, RTP/RTSP protocols, and the like. In alternative embodiments of the present invention, other communications software and transfer protocols may also be used, for example IPX, UDP or the like.

In various embodiments, computer 1120 may include familiar computer components such as a processor 1160, and memory storage devices, such as a random access memory (RAM) 1170, disk drive 1180, and system bus 1190 interconnecting the above components.

In some embodiments, computer 1120 may include one or more Xeon™ microprocessors from Intel Corporation. Further, in the present embodiment, computer 1120 may include a UNIX-based operating system.

It should be understood that embodiments of the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a non-transitory computer readable medium, such as a random access memory (RAM), a read only memory (ROM), a magnetic medium such as a hard-drive or a floppy disk, or an optical medium such as a CD-ROM. Any such non-transitory computer readable medium may reside on or within a single computational apparatus, and may be present on or within different computational apparatuses within a system or network.

The above descriptions are illustrative and are not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

A recitation of “a”, “an” or “the” is intended to mean “one or more” unless specifically indicated to the contrary.

What is claimed is:

1. A method comprising:
sending a viral offer to a communication device associated with a first user, wherein the first user is enrolled with a viral offer program operated by a viral offer server computer;
receiving an authorization request message for a transaction conducted by a second user;
after receiving the authorization request message, accessing a viral offer record associated with the viral offer, wherein the viral offer record includes a velocity limit; and
if the velocity limit has not been met, updating the velocity limit.

2. The method of claim 1, further comprising applying the viral offer to the transaction.

3. The method of claim 1, further comprising:
before receiving the authorization request message for the transaction made by the second user:
generating, based on a relevancy filter, a relevant set of users; and
sending the relevant set of users to the communication device, wherein the relevant set of users includes the second user.

4. The method of claim 1, further comprising, before the sending the viral offer to the communication device, receiving an enrollment request message from the first user, wherein the enrollment request message associates the first user with a financial account.

5. The method of claim 1, wherein the velocity limit is specific to a user record associated with the second user.

6. The method of claim 1, wherein the communication device includes a viral offer client that sends the viral offer to the viral offer server computer.

7. The method of claim 6, wherein the viral offers server computer forwards the viral offer to a second communication device associated with the second user.

8. The method of claim 1, further comprising sending a settlement message after receiving the authorization request message.

9. The method of claim 1, wherein the viral offer server computer receives an indication that the first user has forwarded the viral offer to the second user.

10. A server computer comprising:
a processor and a computer readable storage medium coupled to the processor, the computer readable storage medium comprising code executable by the processor for implementing a method comprising:
sending a viral offer to a communication device associated with a first user, wherein the first user is enrolled with a viral offer program operated by a viral offer server computer;
receiving an authorization request message for a transaction made by a second user;
accessing a viral offer record associated with the viral offer, wherein the viral offer record includes a velocity limit; and
if the velocity limit has not been met, updating the velocity limit.

11. The server computer of claim 10, wherein the method further comprises applying the viral offer to the transaction.

12. The server computer of claim 10, wherein the method further comprises:
before receiving the authorization request message for the transaction made by the second consumer:
generating, based on a relevancy filter, a relevant set of users; and
sending the relevant set of users to the communication device, wherein the relevant set of users includes the second user.

13. The server computer of claim 10, wherein the method further comprises, before the sending the viral offer to the communication device, receiving an enrollment request message from the first user, wherein the enrollment request message associates the first user with a financial account.

14. The server computer of claim 10, wherein the velocity limit is specific to a user record associated with the second user.

15. The server computer of claim 10, wherein the communication device includes a viral offer client that sends the viral offer to the viral offer server computer.

16. The server computer of claim 15, wherein the viral offer server computer forwards the viral offer to a second communication device associated with the second user.

17. The server computer of claim 10, wherein the method further comprises sending a settlement message after receiving the authorization request message.

18. The server computer of claim 10, wherein the viral offer server computer receives an indication that the first user has forwarded the viral offer to the second user.

19. A computer readable medium storing commands for causing a processor to implement the method of claim 1.
